(19) United States
(12) Patent Application Publication
(10) Pub. No.: US 2007/0032950 A1
(43) Pub. Date: Feb. 8, 2007

(54) Modular high-precision navigation system

(75) Inventors: Jason S. O'Flanagan, Round Rock, TX (US); Kevin C. Cobb, Duluth, GA (US); David Anthony Fowler, Elgin, TX (US)

Correspondence Address: ALTERA LAW GROUP, LLC, 6500 CITY WEST PARKWAY, SUITE 100, MINNEAPOLIS, MN, 55344-7704, US

(73) Assignee: Raven Industries, Inc., Sioux Falls, SD (US)

(21) Appl. No.: 11/198,635

(22) Filed: Aug. 5, 2005

(51) Int. Cl. G01C 21/00

(52) U.S. Cl. 701/214; 701/213

(57) ABSTRACT

A modular device, system and associated method, used to enhance the quality and output speed of any generic GPS engine is provided. The modular device comprises an inertial subsystem based on a solid state gyroscope having a plurality of accelerometers and a plurality of angular rate sensors designed to measure linear acceleration and rotation rates around a plurality of axes. The modular inertial device may be placed in the data stream between a standard GPS receiver and a guidance device to enhance the accuracy and increase the frequency of positional solutions. Thus, the modular inertial device accepts standard GPS NMEA input messages from the source GPS receiver, corrects and enhances the GPS data using computed internal roll and pitch information, and produces an improved, more accurate, NMEA format GPS output at preferably 2 times the positional solution rate using GPS alone. The positional solution frequency using the present invention may increase to as much as 5 times that obtained using GPS alone. Moreover, the modular inertial device may assist when the GPS signal is lost for various reasons. If used without GPS, the modular inertial device may be used to define, and adjust, a vehicle's orientation on a relative basis. The modular inertial device and architecturally partitioned system incorporated into an existing GPS system may be applied to navigation generally, including high-precision land-based vehicle positioning, aerial photography, crop dusting, and sonar depth mapping to name a few applications.

### FIELD OF THE INVENTION

This invention relates generally to a navigational system based on improving the quality and frequency of positional solutions through adjusting and/or augmenting global positioning system (GPS) data with inertial positional data.

### BACKGROUND OF THE PRESENT INVENTION

Current global positioning system (GPS) based navigation systems are inherently limited in that the global position determined is actually the position of the associated antenna. The mounting location for this antenna must allow for a clear view of the global positioning satellites orbiting overhead. Generally, for most vehicles, planes, or vessels, the antenna location is not located generally near the desired control point, e.g., the point of highest navigational interest on the ground beneath the area of the vehicle or vessel. This control point may be, e.g., directly beneath a traveling car or truck. For a tractor or other agricultural vehicle pulling an agricultural implement such as a sprayer, the control point may be located beneath the hitch point or beneath the agricultural implement itself. For airborne or waterborne vessels such as planes, helicopters and boats, the control point may be a ground tracking point located directly beneath the vessel, e.g., beneath the center of gravity of the vessel.

Vehicles traveling along an intended path are often subjected to conditions that force the vehicle to change its apparent heading to compensate for a prevailing condition or change in terrain. For example, a ground-based vehicle such as a tractor may be traveling along an intended path as programmed into an assisted steering mechanism and as informed by GPS position solution data. The vehicle travels generally along the intended path as long as the GPS antenna, the vehicle's control point and the intended path are in alignment. However, the tractor may, at times, encounter a side slope, causing the tractor to tilt (pitch and/or roll) wherein the antenna tilts away from the intended path and the tractor's control point. This tilting of the GPS antenna creates an apparent deviation of the GPS antenna from the intended path and the vehicle control point, even though the tractor is actually on the intended path. An external guidance device, e.g., a lightbar, may visually indicate this apparent deviation. In this case, either the operator or an assisted steering mechanism may then act to correct the apparent deviation by steering the tractor away from the intended path in an attempt to bring the tractor's control point into alignment with the intended path. This action corrects the apparent deviation indicated on the lightbar in this example but creates an actual offset error from the intended path. Crop spraying aircraft, e.g., airplanes or helicopters may encounter similar problems due to tilt caused by roll, pitch and/or yaw. In high-precision agricultural applications, as well as many other ground-based applications, such an offset results in an unacceptable expense and coverage error.

Airplanes may be utilized to take aerial photographs for incorporation into a geographic information system (GIS) database. Such photographs must be precisely located within a coordinate system so that the photographs may be registered, allowing a coordinate system to be overlaid on the photo. Once registered, the photographs may be incorporated into a GIS and used to create or update maps. GPS systems may be used on the plane to precisely locate the photograph's position. A digital camera may be mounted to the plane to take photographs and the plane's GPS coordinates may be imprinted on the photographs to facilitate high-precision location for subsequent registration with a GIS. Small variations in the plane's attitude, i.e., roll, pitch and/or yaw, may have a dramatic effect on the position of the plane relative to the section of the earth's surface actually captured in the photograph. This results in coordinate location errors, and subsequent difficulties and errors in registration and incorporation in a GIS. Similar problems may occur when boats are equipped with sonar mapping equipment. The boat may roll, pitch and/or yaw with the waves, causing location problems and potential inaccuracies in the mapping data.

The offset errors described above are influenced principally by two factors, the height of the GPS antenna above the ground control point and the degree of the tilt. As either the degree of tilt or the antenna height increases, the associated offset error also increases.

In order to avoid the above-mentioned problems, a precise measurement of the attitude of the vehicle or vessel with respect to the navigation coordinate system must be made. To achieve this, an inertial navigation system (INS) may be used alone or, alternatively, in conjunction with a global positioning system. Used alone, an INS may provide precise orientation or attitude information about the vehicle and allow for relative adjustment thereof. Used in conjunction with a GPS, the INS may augment the GPS position solutions to create intermediate positions between the GPS output. The GPS/INS may also adjust the position using roll, pitch and yaw data to measure a position where the control point is located away from the GPS antenna position on the vehicle or vessel. These augmented and adjusted positions may then be provided to external devices such as an assisted steering guidance device or controller, a lightbar, data logger and the like.

Known INS methods and systems are able to sense the attitude of an accelerating or moving object. In such known systems, attitude sensing is accomplished by measuring acceleration in three orthogonal axes and measuring angular rate about each such axis to compute attitude accurately relative to a vertical axis. Further, these systems comprise a processor that updates a quarternion representation of the attitude based upon the angular rate of the object and a corrective rate signal to obtain the attitude of the object. Sensor temperature compensation may be used to calibrate and update the quarternion. Such methods and systems are described in U.S. Pat. Nos. 6,421,622, 6,647,352, and 6,853,947, the disclosures of which are incorporated herein by reference in their entirety. These known INS methods do not, however, use GPS data to condition and/or calibrate the INS system. Without the GPS data, such systems will provide poor absolute positioning over time. With GPS data the INS sensor data precision can be improved to approximately 99%. Thus, for applications requiring precise positioning, including latitude, longitude and attitude, such known systems and methods are lacking and require improvement.

Devices do currently exist that allow combination of INS and GPS data to improve positioning precision. However, in the current state of the art, the GPS/INS units are integrated. This integrated design creates several problems. Such integration inhibits individualized design of the system components through element-by-element upgrades to the system. Thus, integrated GPS/INS units are inherently limited in that they do not allow for variation of system component configuration as technology advances. If a technological advance regarding the INS component becomes available, it becomes necessary with current state-of-the-art units to replace the entire integrated unit to achieve enhanced performance at relatively large expense. Similarly, existing systems do not allow the operator to elect to use a particular DGPS receiver in conjunction with a particular INS module to achieve optimal performance or to customize the performance to a particular need. Moreover, these integrated unpartitioned units also fail to provide for individual system component maintenance and/or replacement if a component malfunctions or requires service.

Accordingly, it is desirable to provide a high-precision modular navigation system that uses inertial augmentation of GPS signals to provide orientation information for a vehicle and/or vessel. It would be further desirable to combine GPS and INS functionality in a modular and architecturally partitioned design to augment the GPS position solution to create more accurate and more frequent intermediate positions between the GPS output and to adjust the position solution for roll, pitch and yaw where the control point is located away from the GPS antenna location.

### SUMMARY OF THE INVENTION

A modular device, system and associated method, used to enhance the quality and output speed of any generic GPS engine is provided. The modular device comprises an inertial subsystem based on a solid state gyroscope having a plurality of accelerometers and a plurality of angular rate sensors designed to measure linear acceleration and rotation rates around a plurality of axes. The modular inertial device may be placed in the data stream between a standard GPS receiver and a guidance device to enhance the accuracy and increase the frequency of positional solutions. Thus, the modular inertial device accepts standard GPS NMEA input messages from the source GPS receiver, corrects and enhances the GPS data using computed internal roll and pitch information, and produces an improved, more accurate, NMEA format GPS output at preferably 2 times the positional solution rate using GPS alone. The positional solution frequency using the present invention may increase to as much as 5 times that obtained using GPS alone. Moreover, the modular inertial device may assist when the GPS signal is lost for various reasons. If used without GPS, the modular inertial device may be used to define, and adjust, a vehicle's orientation on a relative basis. The modular inertial device and architecturally partitioned system incorporated into an existing GPS system may be applied to navigation generally, including high-precision land-based vehicle positioning, aerial photography, crop dusting, and sonar depth mapping to name a few applications.

An object of various embodiments of the invention is to provide an improved modular high-precision navigation system that accurately defines the position and orientation of a vehicle or vessel.

Another object of various embodiments of the invention is to provide an improved modular high-precision navigation system incorporating an inertial system module to augment and/or adjust GPS data to improve positional solution accuracy.

Yet another object of various embodiments of the invention is to provide a modular high-precision navigation system that uses inertial data in combination with GPS data to adjust the position solution based on roll, tilt and yaw.

Another object of various embodiments of the invention is to provide a modular high-precision navigation system that uses inertial data in combination with GPS data to adjust to GPS antenna displacement from an intended path.

Yet another object of various embodiments of the invention is to provide a modular high-precision navigation system that uses inertial data in combination with GPS data to provide a corrected visual guidance display when the GPS antenna is displaced from an intended path.

Still another object of various embodiments of the invention is to provide a modular high-precision navigation system that uses inertial data to calculate intermediate positions between the GPS solutions resulting in an increased the frequency of positional solutions.

The foregoing objects of various embodiments of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 is a block diagram of one embodiment of the high-precision inertial navigation module.

FIG. 2 is a schematic representation of the X,Y,Z axes comprising the orthogonal coordinate system used by the inertial module.

FIG. 3 is a block diagram of one embodiment of the high-precision navigation system, incorporating the inertial navigation module in the GPS data stream.

FIG. 4 is a diagram of one embodiment of the high-precision navigation system, incorporating the inertial navigation module in the GPS data stream.

FIG. 5 is a process flow diagram.

FIG. 6 is a rear view of a tractor pulling an agricultural implement on a side slope.

FIG. 7a is a top view of a tractor on a side slope with the tractor's actual course and observed course with a prior art navigational system resulting in a lightbar showing an apparent offset error.

FIG. 7b is a top view of a tractor on a side slope with the tractor's actual course and observed course with a corrected lightbar display using the present invention.

FIG. 8a provides an airplane taking an aerial photograph and illustrating an offset error due to tilt.

FIG. 8b provides a boat performing sonar mapping and illustrating an offset error due to tilt.

### DETAILED DESCRIPTION OF THE INVENTION

With reference to the accompanying figures, there is provided a high-precision inertial navigation module, a high-precision inertial navigation system incorporating the inertial module and associated method.

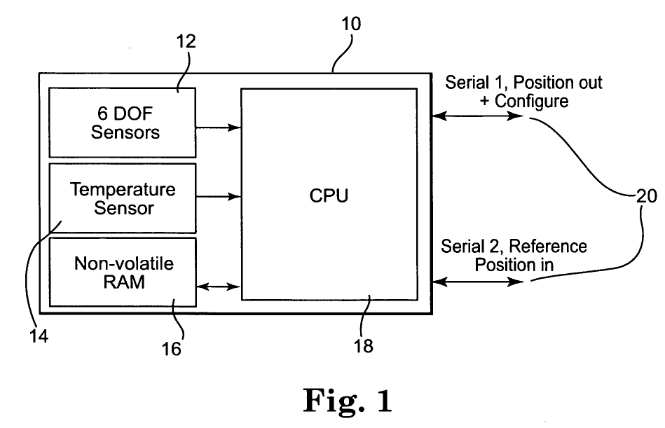

With specific reference to FIG. 1, one embodiment of a high-precision inertial navigation module 10 is provided. The module 10 comprises a gyroscope having six sensors 12, including a plurality, preferably three, accelerometers to measure acceleration along three axes (X,Y,Z) and a plurality, preferably three, angular rate sensors for measuring angular rotation around the X,Y, and Z axes. The module 10 further comprises a temperature sensor 14 to compensate and/or calibrate the sensors for performance or response variation due to variation in temperature. The module 10 also comprises non-volatile RAM 16 for storing certain calibration and discipline information for the module 10. A processor 18 is also provided, e.g., a CPU in the illustrated embodiment. The module 10 has at least two serial ports 20 for “plugging into” the navigational system and for sending and receiving positional data.

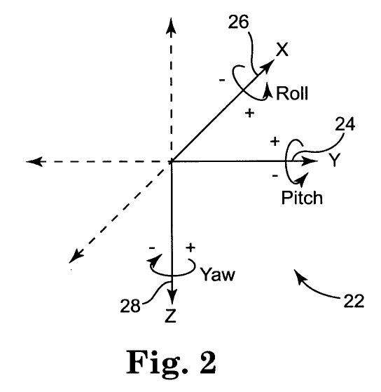

Referring now to FIG. 2, a representation of the coordinate set of axes X,Y, and Z 22 designating directions of movement or orientation, i.e., attitude as used by the inertial module is illustrated. Rotational motions about the axes are: “pitch”, defined as rotation about the Y axis 24 in the XZ plane; “roll”, defined as rotation about the X axis 26 in the YZ plane; and “yaw”, defined as rotation about Z axis 28 in the XY plane. Yaw is also referred to commonly as “heading”. The axes form an orthogonal right-handed coordinate system. Acceleration in this system is thus positive when it is oriented towards the positive side of the coordinate axis as illustrated. Gravitational acceleration is directed downward, thus downward acceleration is defined as positive. For example, with the module sitting on a level surface at sea level, the gyroscope will measure 0 g along the X 26 and Y 24 axes and +1 g along the Z axis 28.

The three angular rate sensors of the inertial module's gyroscope are aligned with the X 26, Y 24 and Z 28 axes as illustrated with the direction of a positive rotation defined by the right-hand rule, well known to those skilled in the art. Thus, an upward pitch is defined as positive for a positive rotation about the Y-axis 24. Similarly, a roll to the right is defined as positive roll for a positive rotation about the X-axis 26. The angles involved are defined as standard Euler angles using a 3-2-1 system also well known to the skilled artisan.

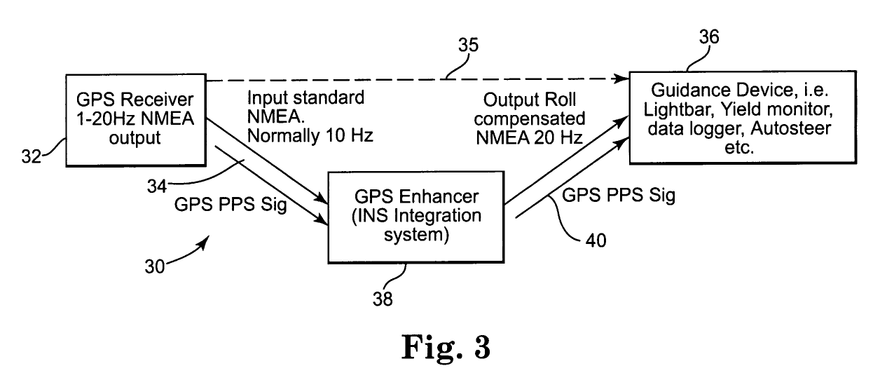

With reference now to FIG. 3, a basic block diagram 30 of the inertial module “plugged into” an existing GPS data stream is illustrated. Here, the GPS receiver 32 is shown outputting NMEA data 34. In prior art systems, such NMEA data 34 would be directly provided to the guidance device 36, as illustrated by the dotted line 35 connecting the GPS receiver 32 and the guidance device 36. This prior art configuration results in the flawed positional data described above.

By contrast, the inventive module 38 is placed in the GPS data stream. Thus, the inertial module 38 is in communication with the GPS receiver 32 and receives the NMEA data output 34 from the GPS receiver 32, processes it for roll, pitch and yaw, and relative antenna position, and communicates the updated, corrected data to the guidance device 36. Ultimately, the inertial module 38 may produce an NMEA output 40 that is more accurate and more frequent than the NMEA output 34 from the GPS receiver 32 alone. The inertial module may augment the GPS data output by computing interim positional solutions at a more frequent rate than the GPS receiver is capable of achieving. As shown in FIG. 3, the GPS receiver 32 is shown providing an standard NMEA data stream 34 at a frequency of 10 Hz. The inertial module 38 receives this NMEA data stream 34, augments it and outputs roll/tilt compensated NMEA data 40 at a frequency of 20 Hz, twice that of the GPS receiver NMEA data output 34. Such frequency may be twice the GPS receiver output-input rate 34 into the inertial module, as in the example, and may be updated as frequently as three, four or five times that of the GPS output rate 34 from the GPS receiver.

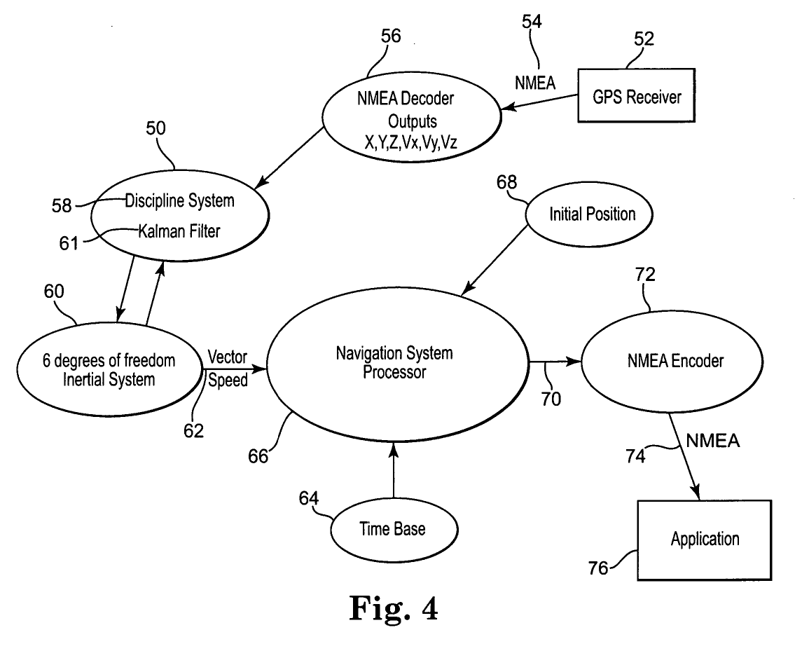

Referring now to FIG. 4, a more detailed description of the modular high-precision navigation system is provided 50.

In a preferred embodiment, the GPS data, outputted from a GPS receiver in NMEA standard format at a certain frequency, is used to discipline the inertial module's six sensors to create a more precise position solution. The GPS receiver is not integrated with the inertial system in the present invention. Rather, the inertial module is architecturally partitioned within the system so that it may be placed, or plugged into, in the data flow between an existing GPS receiver and a Guidance device, e.g., a lightbar, yield monitor, data logger, or auto-steering system and the like. As a result, the inertial module may be added to existing systems to enhance the precision of position solutions.

Turning now specifically to FIG. 4, the NMEA data output 54 by the GPS receiver 52 is decoded by an NMEA data decoder 56 and then provided or communicated to a discipline system 58 where it is used to calibrate the sensors 60 within the inertial module to increase the precision of the sensors. Thus, as shown, the inertial module is in two-way communication with the discipline system. The discipline system 58 is capable of calibrating the inertial module sensors 60 and to remove drift over time and with temperature. A Kalman Filter 61 may be provided to receive the sensor data from the inertial module sensors 60 and further use the data to calculate a position as is well known to those skilled in the art. Such data is transformed into a navigational or position solution comprising a vector and speed 62. This position solution is communicated, as is the time using a time base 64, to the inertial module processor 66 which uses the vector, speed, inertial data and time to create a new position solution including compensation for attitude or orientation.

The initial start position 68 may be provided. However, if a start position is not provided, the processor may default to a starting position of sea level with a latitude of 0 degrees and a longitude of 0 degrees. Ultimately, the position or navigational solution is then sent or communicated 70 to the NMEA encoder 72 to create an NMEA data packet 74 that is sent to an external device 76, e.g., a lightbar, data logger, assisted or automatic steering system and the like.

The inventive inertial module thus may accept standard NMEA input messages from the GPS receiver. The inertial module then corrects and enhances this GPS data using the internal roll, pitch and yaw data from the gyroscopic sensors to produce an improved, more precise NMEA format GPS output. In one embodiment, the inertial module may delay the roll, pitch and yaw data to match delays in the processing of the GPS position data received from the GPS receiver. In this manner, the roll and pitch data for example, may be stored for up to 150 ms and then applied to the corresponding GPS data as it is ultimately received by the inertial module. Thus, one embodiment may provide for the measurement of the delay needed to process and receive the GPS data within the inertial module. This measurement may then be applied within the inertial module wherein the GPS data is corrected by the inertial data.

In addition to increasing the precision of the NMEA data, utilization of the inertial module in this manner allows for more frequent updates of the position solution as compared with position solutions based solely on GPS data, further increasing the precision of position solutions using the inventive system. Thus, the decoded NMEA GPS data, tilt-compensated based on the inertial module angular rate and linear acceleration signals, are output at twice the rate of the input data rate.

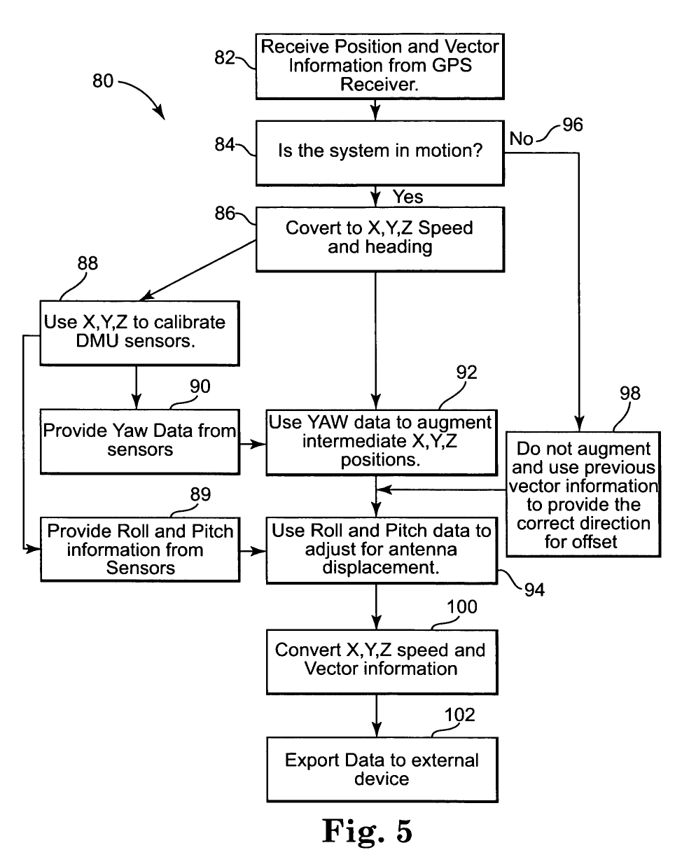

Turning to FIG. 5, one embodiment of the method for improving the accuracy and increasing the frequency of position solutions 80 will now be described in detail.

The position and vector information is initially determined by the GPS receiver and is received therein. If the system is in motion 84, the GPS NMEA data is converted or decoded to X,Y,Z, Speed and heading 86. The X,Y,Z data may then be used to calibrate the inertial module's gyroscopic sensors 88. These gyroscopic sensors are capable of providing roll, pitch 89 and yaw 90 data. This yaw data 90 may be used to augment the intermediate GPS X,Y,Z data 92 obtained in step 86 if the system is in motion. The roll and pitch data 89 from the gyroscopic sensors may be used to adjust the GPS data for, e.g., antenna displacement away from the intended path 94.

If, after the GPS data is received in step 82, the system is determined to not be in motion 96, augmentation using yaw data obtained from the gyroscopic sensors is not performed 98. Instead, the GPS data is used to provide the correct direction for any offset that may be observed 98. Then the roll and pitch data from the gyroscopic sensors is utilized as described above to adjust for any antenna displacement 94. Ultimately, the adjusted, more accurate, data is encoded into NMEA data format 100 and exported or communicated to an external device such as a guidance device, i.e., a lightbar or the like 102.

An exemplary GPS receiver that may provide submeter accuracy is found in the Invicta™ DGPS line of receivers provided by Raven Industries, Sioux Falls, S. Dak. However, the partitioned design of the inventive system allows virtually any GPS or DGPS-enabled receiver to be “plugged into” the system. This aspect of the invention is particularly advantageous as the technology regarding DGPS tracking solutions is continuously evolving and improving. The partitioned system disclosed and claimed herein allows all currently existing DGPS-enabled receivers and guidance devices to be used within the system while allowing future DGPS, guidance device and/or inertial module technology improvements or advancements to be easily integrated into the inventive system.

Various embodiments of the inventive system may utilize GPS and DGPS signals in combination with the inertial signals provided by the gyroscope. However, the invention described herein is certainly not limited to GPS or DGPS signals. Any external positioning system that provides real time positioning data will work within the system and is within the scope of the invention as will those skilled in the art readily recognize.

Thus, the position solution provided by the inventive system to the guidance device or unit, e.g., lightbar, may comprise vehicle position, orientation and course-over-ground, i.e., the navigational path traversed by the vehicle, including speed of the vehicle and relative orientation, to the guidance unit. The guidance unit may then compare the positional solution data with the intended target path previously entered into the guidance unit, e.g., lightbar, by the operator and stored within the unit's memory. In the case where the guidance unit is a lightbar, a processor within the lightbar may then calculate guidance error comprising the level of offset from the intended target path as well as the angle error from the intended target path. The guidance error may be displayed graphically and/or numerically on an operator display interface disposed on the lightbar. In addition, safety warnings and/or safety indicators may be displayed by the lightbar.

The guidance unit may be located on a vehicle, vessel or craft to be automatically steered or steered by the operator with navigational assistance. An embodiment of such a guidance unit may be a lightbar. Such lightbars are well known in the art, a description may be found in U.S. Pat. No. 6,104,979 to Starlink, Inc., a predecessor of the instant patent application's assignee Raven Industries. U.S. Pat. No. 6,104,979 is incorporated herein by reference. An exemplary lightbar that may be used in an embodiment of the system is the RGL 600 Smartbar™ manufactured and sold by Raven Industries Flow Control Division, 205 East Sixth Street, P.O. Box 5107, Sioux Falls, S. Dak. 57117.

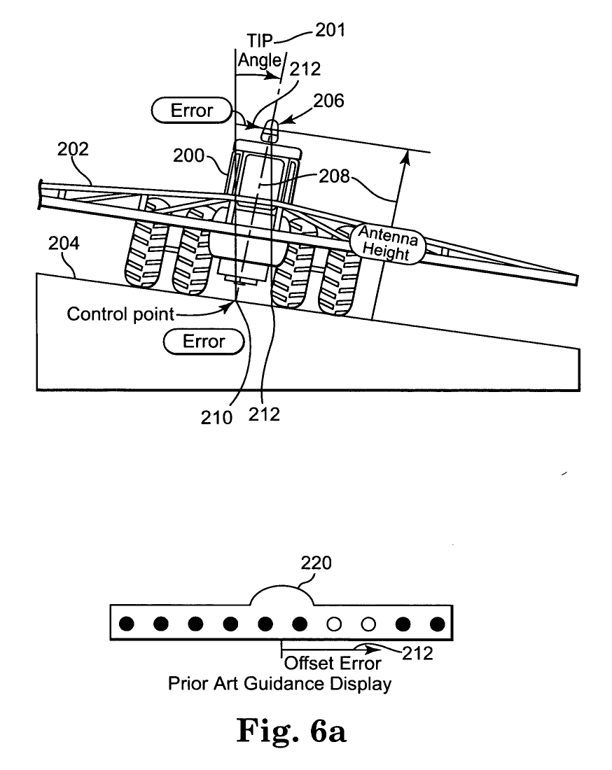

FIGS. 6a and 6b provide a specific example of how the inventive inertial module functioning in a system comprising a lightbar as the guidance unit or device. FIG. 6a provides a rear view of a ground vehicle 200, specifically in this embodiment a tractor, pulling an agricultural implement 202 on a side slope 204. The navigation system provided in this embodiment comprises a GPS receiver and GPS antenna in combination with the inertial module including a six-degree of freedom gyroscope plugged into the GPS system, not shown in FIG. 6a, but as provided in FIG. 3. The GPS antenna 206 is mounted on the tractor 200 at a point providing a clear view of the global positioning satellites of the global positioning system. As illustrated, the GPS antenna 206 is mounted at a point distanced from the control point 210 of the ground vehicle or tractor 200. The control point 210 of the vehicle 200 is defined as a point on the ground directly vertically beneath the GPS antenna 206.

In general, a GPS system provides reasonably accurate navigation, and assisted steering as described above, when the traversed ground is level wherein the GPS antenna 206 is vertically aligned with the vehicle control point 210 and no offset error results. However, when the vehicle 200 traverses terrain that is not level, the GPS antenna 206 and the vehicle control point 210 come out of alignment as the vehicle pitches, rolls and yaws. Such offset error events may be relatively short or transitory, e.g., the vehicle crosses a dead furrow in a field. Conversely, there are occasions when the misalignments are not transitory as when the vehicle 200 encounters a side slope, with the vehicle (and GPS antenna) tilting in response, thus resulting in an offset error.

FIGS. 6a and 6b illustrate the offset error 212 in a side slope scenario. The GPS antenna 206 is shown tilted with the vehicle's 200 tilt 201 to the right, or downhill, and out of alignment with the vehicle's control point 210. The offset error 212 is represented by the shift of the GPS antenna 206 away from the control point 210.

Significantly, as the height of the antenna from the ground control point increases 208, so does the magnitude of the associated offset error 212. These effects become increasingly significant particularly with an increase in antenna height 208 from the ground control point 210.

### Offset Error as a Function of Antenna Height and Degree of Tilt from Ground Control Point

| | Antenna Height/Distance From Ground Control Point | | |
|---|---|---|---|
| Degree of Tilt | 3.0 meters | 4.0 meters | 5.0 meters |
| 1 degree | 0.05 m | 0.07 m | 0.09 m |
| 5 degrees | 0.26 m | 0.35 m | 0.44 m |
| 10 degrees | 0.52 m | 0.69 m | 0.87 m |
| 15 degrees | 0.78 m | 1.03 m | 1.29 m |

As the above table indicates, the offset error 212 may become dramatic if the GPS antenna height from the ground control point 208 and/or the degree of tilt away from the ground control point 201 become large. Thus, particularly acute problems may exist in connection with aircraft and watercraft in part because of the height involved. Moreover, because of the accuracy required in agricultural applications, e.g., spraying, even very slight offset errors may result in great inefficiencies.

The exemplary prior art light bar 220 of FIG. 6a thus indicates an apparent deviation correspondent to the offset error 212 illustrating that either the operator or an assisted steering system may attempt to correct. However, the process of correcting this apparent offset deviation 212 has the effect of creating an actual offset error as compared with the intended path. In the example, the tendency would be to attempt to “correct” the apparent offset 212 by steering the tractor in the downhill direction and off the intended path.

The inventive EINS module, or in certain embodiments the EINS assembly which combines GPS and inertial data, eliminates this error by determining, and compensating for, the ground vehicle's attitude, i.e., the pitch, roll and yaw. Thus, FIG. 6b illustrates the subject tractor 200 on a side slope but this time with a corrected lightbar display 220 using the present invention. The inventive EINS module and assembly accomplish this by utilizing the inertial data obtained to calculate a roll and pitch, i.e., tilt. Thus, the position solution data provided to the lightbar 220 is corrected for the tilt and compensates therefor to provide the corrected lightbar display 220 of FIG. 6b. As a result, the ground vehicle 200 remains on the intended path and neither the operator nor the assisted steering system is prompted to deviate from the intended path as a consequence of an apparent offset error.

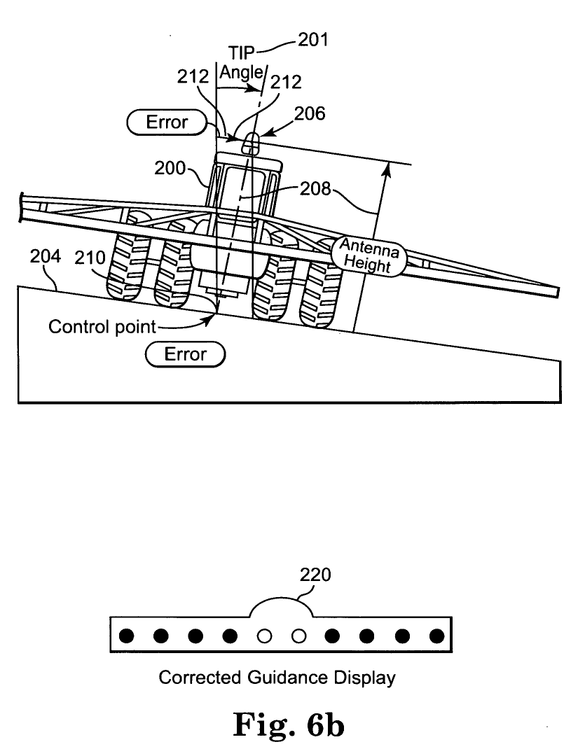

The inventive modular navigation system also has application in the taking of aerial photographs. FIGS. 7a and 7b illustrate an offset error due to tilt of the airplane 300 to which a camera is attached, not shown in the Figures, but well known to those skilled in the art. FIG. 7a illustrates the lateral offset 302 that may result from a change in roll attitude while FIG. 7b provides illustration of a longitudinal offset 304 resulting from a change in pitch. It is understood that the plane may simultaneously roll and change its pitch, thus compounding the offset error. As discussed above, the two primary factors contributing to the offset error are height of the GPS antenna above the ground control point and the degree of tilt. In aviation applications, the heights involved can be quite large, making even a small degree of pitch and/or roll extremely significant and resulting in large offsets.

Airplanes may be utilized to take aerial photographs for incorporation into a geographic information system (GIS) database. Such photographs must be precisely located within a coordinate system so that the photographs may be registered, allowing a coordinate system to be overlaid on the photo. Once registered, the photographs may be incorporated into a GIS and used to create or update maps. GPS systems may be used on the plane to precisely locate the photograph's position. A digital camera may be mounted to the plane to take photographs and the plane's GPS coordinates may be imprinted on the photographs to facilitate high-precision location for subsequent registration with a GIS. Because of the height involved from the GPS antenna to the ground control point, small variations in the plane's attitude, i.e., roll or pitch, may have a dramatic effect on the position of the plane relative to the section of the earth's surface actually captured in the photograph. This results in coordinate location errors, and subsequent difficulties and errors in registration and incorporation in a GIS.

The inventive modular navigation system, in various embodiments, the EINS assembly, including a GPS system combined with an inertial system, may be used to define the plane's attitude at the moment a photograph is taken. This allows for correction or compensation of either a lateral offset 302 due to roll, a longitudinal offset 304 due to pitch, or a combination of roll and pitch resulting in tilt. Such corrected location data may be recorded with the photograph for future reference and registering. Moreover, this data may be provided to the pilot to assist in navigation so that photograph locations that are intended are actually photographed.

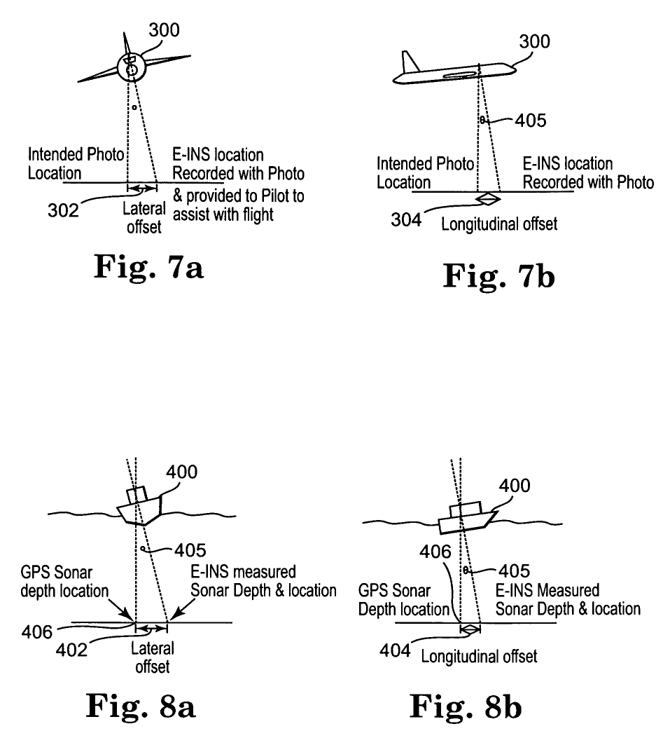

Similar problems result in the case of waterborne vessels doing sonar depth mapping of the floor of a body of water. As illustrated by FIGS. 8a and 8b, a boat 400 is provided in the process of sonar mapping. The boat 400 in FIG. 8a is shown with a lateral offset error 402 due to roll resulting from wave action on the boat. The boat in FIG. 8b is illustrated with a longitudinal offset error 404 due to a change in pitch due to wave action. As described above in connection with the aircraft, it is understood that the offset error associated with a boat in open water may be a combination of changes in roll and pitch.

Sonar depth sensors utilize acoustic energy to collect measurements of the floor of bodies of water and the character thereof. The sonar sensors issue pulses of acoustic energy intended to be normal to the track of the vessel and record the reflected echoes. As FIGS. 8a and 8b illustrate, the boat 400 may roll and/or pitch in response to wave action. This may cause the acoustic energy pulses to leave the boat at some angle 405 to the control point 406, or the intended sonar depth location located directly beneath the boat. This results in a longer path for the energy pulses to reach the floor of the body of water than if the energy had been pulsed to the control point. An equally long path is required for the energy pulse to be reflected back to the ship. The net result is error in the location of geographic structures on the floor, the shape of such structures, as well as water depth measurement errors.

The inventive modular navigation system, in various embodiments, may be used to define the vessel's attitude at the moment each burst of acoustic energy is emitted. This allows for correction or compensation of either a lateral offset due to roll, a longitudinal offset due to pitch, or a combination of roll and pitch resulting in tilt. Such corrected location data may be recorded with the acoustic energy pulse to allow for accurate depth measurement by compensating for the boat's attitude at the time the acoustic energy pulse was sent. In addition, the boat's attitude at the time the returning acoustic energy pulse is received may be included in the analysis to account for any roll and/or pitch that may skew the depth results.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below.

What is claimed is:

1. A modular inertial subsystem for incorporation into an existing global positioning (GPS) system and for determining an accurate position of an accelerating object traveling along an intended path programmed into an external guidance device, wherein the GPS system is mounted on the object and includes a GPS receiver and a GPS antenna, and wherein the GPS system provides correlation measurements associated with signals received from a plurality of GPS satellites, the inertial subsystem comprising:
at least two serial ports on the inertial subsystem for communication with the GPS system;
three acceleration sensors aligned with each of three orthogonally-oriented axes of rotation of the object for providing lateral acceleration data;
three angular rate sensors aligned with each of the three orthogonally-oriented axes of rotation of the object for providing angular rate data;
a processor in communication with the GPS receiver for receiving the GPS data at an established frequency rate and in further communication with the acceleration sensors for receiving the acceleration data and the angular rate sensors for receiving the angular rate data, wherein the processor converts the NMEA-format GPS data received from the GPS receiver into an orthogonal axis position, speed and heading;
calibrates the angular rate and acceleration sensors using the converted GPS data;
determines yaw, pitch and roll values from the sensors;
uses the yaw value to augment the converted GPS positions;
uses the pitch and roll values to adjust the converted GPS positions for offset error of the GPS antenna from the intended path; and
converts the adjusted and augmented GPS positions into NMEA format for communication to the external guidance device, wherein the communication between the modular inertial subsystem and the external guidance device is occurring at a frequency rate that is higher than the established frequency rate of NMEA-format data communication between the GPS receiver and the modular inertial subsystem.

2. The modular inertial subsystem of claim 1, further comprising a temperature sensor in communication with the processor for obtaining a temperature value and for adjusting the angular rate and acceleration sensor data based on temperature variation, and wherein the processor adjusts the angular rate and acceleration sensor data based on the temperature value.

3. The modular inertial subsystem of claim 1, wherein the frequency of communication of adjusted and augmented NMEA-format GPS position data to the external guidance device from the inertial subsystem is at least twice the frequency rate of communication of NMEA-format GPS data received by the modular inertial subsystem from the GPS receiver.

4. The modular inertial subsystem of claim 1, wherein the frequency of communication of adjusted and augmented NMEA-format GPS position data to the external guidance device from the inertial subsystem is at least three times the frequency rate of communication of NMEA-format GPS data received by the modular inertial subsystem from the GPS receiver.

5. The modular inertial subsystem of claim 1, wherein the frequency of communication of adjusted and augmented NMEA-format GPS position data to the external guidance device from the inertial subsystem is at least four times the frequency rate of communication of NMEA-format GPS data received by the modular inertial subsystem from the GPS receiver.

6. The modular inertial subsystem of claim 1, wherein the frequency of communication of adjusted and augmented NMEA-format GPS position data to the external guidance device from the inertial subsystem is at least five times the frequency rate of communication of NMEA-format GPS data received by the modular inertial subsystem from the GPS receiver.

7. The modular inertial subsystem of claim 1, further comprising the external guidance device being selected from the group consisting of a lightbar, an assisted steering system, a computer, a datalogger and a monitor.

8. The modular inertial subsystem of claim 1, wherein the accelerating object comprises a vehicle, vessel or craft.

9. A modular inertial subsystem for incorporation into an existing global positioning (GPS) system and for determining an accurate position of an accelerating vehicle, vessel or craft, wherein the GPS system includes a GPS receiver and a GPS antenna, and wherein the GPS system provides correlation measurements associated with signals received from a plurality of GPS satellites, the inertial subsystem comprising:
at least two serial ports on the inertial subsystem for communication with the GPS system;
three acceleration sensors aligned with each of three orthogonally-oriented axes of rotation of the object for providing lateral acceleration data;
three angular rate sensors aligned with each of the three orthogonally-oriented axes of rotation of the object for providing angular rate data;
a processor in communication with the GPS receiver for receiving the GPS data at an established frequency rate and in further communication with the acceleration sensors for receiving the acceleration data and the angular rate sensors for receiving the angular rate data, wherein the processor executes a computer program that performs the steps of:
converting the NMEA-format GPS data received from the GPS receiver into an orthogonal axis position, speed and heading;
calibrating the angular rate and acceleration sensors using the converted GPS data;
determining yaw, pitch and roll values from the sensors; using the yaw value to augment the converted GPS positions;
using the pitch and roll values to adjust the converted GPS positions for offset error; and
converting the adjusted and augmented GPS positions into NMEA format for communication to an external guidance device, the communication occurring at a frequency rate that is higher than the established frequency rate of NMEA-format data communication between the GPS receiver and the modular inertial subsystem; and
a temperature sensor in communication with the processor to compensate the angular rate and acceleration sensor data based on temperature variation,
wherein the external guidance device is selected from the group consisting of a lightbar, an assisted steering system, a computer, a datalogger, and a monitor.

10. A modular inertial/global positioning system (GPS) for determining the position of an accelerating object, wherein the modular inertial/GPS system is mounted on the object and comprising:
a GPS antenna receiving a positioning signal from a GPS system;
a modular GPS receiver in communication with the GPS antenna for receiving the positioning signal and for generating NMEA-format navigation data for the object at an established frequency rate;
an external guidance device for assisted steering of the object;
a modular inertial subsystem in communication with the GPS receiver for receiving, adjusting and augmenting the NMEA-format navigation data, the inertial subsystem being in further communication with the external guidance device and comprising:
at least two serial ports on the inertial subsystem for communication with the GPS system;
three acceleration sensors aligned with each of three orthogonally-oriented axes of rotation of the object for providing lateral acceleration data;
three angular rate sensors aligned with each of the three orthogonally-oriented axes of rotation of the object for providing angular rate data;
a temperature sensor to compensate the angular rate and acceleration sensor data based on temperature variation
a processor in communication with the GPS receiver for receiving the GPS data at an established frequency rate and in further communication with the acceleration sensors for receiving the acceleration data and the angular rate sensors for receiving the angular rate data and the temperature sensor for temperature-based compensation of the sensor data, wherein the processor executes a computer program that performs the steps of:
converting the NMEA-format GPS data received from the GPS receiver into an orthogonal axis position, speed and heading;
calibrating the angular rate and acceleration sensors using the converted GPS data;
determining yaw, pitch and roll values from the sensors;
adjusting the yaw, pitch and roll values for temperature;
using the temperature-adjusted yaw value to augment the converted GPS positions;
using the temperature-adjusted pitch and roll values to adjust the converted GPS positions for offset error; and
converting the adjusted and augmented GPS positions into NMEA format for communication to an external guidance device, the communication occurring at a frequency rate that is higher than the established frequency rate of NMEA-format data communication between the GPS receiver and the modular inertial subsystem.

11. The modular inertial/global positioning system of claim 10, wherein the frequency of communication of adjusted and augmented NMEA-format GPS position data to the external guidance device from the inertial subsystem is at least twice the established frequency rate of communication of NMEA-format GPS data received by the modular inertial subsystem from the GPS receiver.

12. The modular inertial/global positioning system of claim 10, wherein the frequency of communication of adjusted and augmented NMEA-format GPS position data to the external guidance device from the inertial subsystem is at least three times the established frequency rate of communication of NMEA-format GPS data received by the modular inertial subsystem from the GPS receiver.

13. The modular inertial/global positioning system of claim 10, wherein the frequency of communication of adjusted and augmented NMEA-format GPS position data to the external guidance device from the inertial subsystem is at least four times the established frequency rate of communication of NMEA-format GPS data received by the modular inertial subsystem from the GPS receiver.

14. The modular inertial/global positioning system of claim 10, wherein the frequency of communication of adjusted and augmented NMEA-format GPS position data to the external guidance device from the inertial subsystem is at least five times the established frequency rate of communication of NMEA-format GPS data received by the modular inertial subsystem from the GPS receiver.

15. The modular inertial/global positioning system of claim 10, wherein the external guidance device is selected from the group consisting of a lightbar, an assisted steering system, a computer, a datalogger, and a monitor.

16. The modular inertial/global positioning system of claim 10, wherein the accelerating object comprises a vehicle, vessel or craft.

17. A method of increasing the quality and frequency of position solutions provided by a global positioning system (GPS) that is mounted on an accelerating object, comprising:
providing an accelerating object, with a GPS system, including a GPS antenna GPS receiver for receiving signals from a plurality of GPS satellites, mounted thereon;
providing an external guidance system, in communication with the GPS system and for assisting in the navigation of the object;
adding to the GPS system, a modular inertial subsystem, wherein the inertial subsystem is in communication with the GPS receiver and with the external guidance system;
receiving NMEA-format GPS data with the GPS receiver, at an established standard frequency rate;
communicating the NMEA-format GPS data to the modular inertial subsystem;
converting the NMEA-format GPS data received from the GPS receiver into an orthogonal axis position, speed and heading;
calibrating the angular rate and acceleration sensors of the modular inertial subsystem using the converted GPS data;
determining yaw, pitch and roll values from the sensors;
adjusting the yaw, pitch and roll values for temperature;
using the temperature-adjusted yaw value to augment the converted GPS positions;
using the temperature-adjusted pitch and roll values to adjust the converted GPS positions for offset error; and
converting the adjusted and augmented GPS positions into NMEA format for communication to the external guidance device, the communication occurring at a frequency rate that is higher than the established frequency rate of NMEA-format data communication between the GPS receiver and the modular inertial subsystem.

18. The method of claim 17, wherein the communication from the inertial module to the external guidance device occurs at a frequency rate that is twice that of the established frequency rate of NMEA-format data communication between the GPS receiver and the modular inertial subsystem.

19. The method of claim 17, wherein the communication from the inertial module to the external guidance device occurs at a frequency rate that is three times that of the established frequency rate of NMEA-format data communication between the GPS receiver and the modular inertial subsystem.

20. The method of claim 17, wherein the communication from the inertial module to the external guidance device occurs at a frequency rate that is four times that of the established frequency rate of NMEA-format data communication between the GPS receiver and the modular inertial subsystem.

21. The method of claim 17, wherein the communication from the inertial module to the external guidance device occurs at a frequency rate that is five times that of the established frequency rate of NMEA-format data communication between the GPS receiver and the modular inertial subsystem.

22. The method of claim 17, wherein the external guidance device is selected from the group consisting of a lightbar, an assisted steering system, a datalogger, a computer, and a monitor.

23. The method of claim 17, further comprising:
measuring the delay required to process the GPS data and receive the GPS data within the inertial module;
storing the corresponding yaw, roll and pitch data; and
applying the stored yaw, roll and pitch data to the delayed GPS data.

24. The method of claim 23, further comprising the storing of the yaw, roll and pitch data extending up to 150 ms.

25. A method of increasing the accuracy of geographic coordinate location of aerial photographs, comprising:
providing an airborne craft having a digital camera for taking aerial photographs mounted thereon;
providing a GPS system on the craft, comprising a GPS antenna and a GPS receiver;
adding to the GPS system a modular inertial subsystem to compensate for variation in the airborne craft's attitude;
correcting the GPS coordinates based on inertial data obtained by the modular inertial subsystem;
taking at least one aerial photograph with the digital camera; and
labeling each photograph with the corresponding corrected GPS coordinates to facilitate high-precision location of the photograph.

26. The method of claim 25, further comprising providing the corrected GPS coordinates to the pilot or other personnel to facilitate navigation.

27. A method of increasing the accuracy of sonar depth mapping of the floor of a body of water, comprising:
providing a waterborne-vessel having at least one sonar depth sensor mounted thereon for issuing pulses of acoustic energy and recording the echoes reflected from the floor of the body of water;
providing a GPS system on the vessel, comprising a GPS antenna and a GPS receiver;
adding to the GPS system a modular inertial subsystem to compensate for variation in the vessel's attitude;
correcting the GPS coordinates based on inertial data obtained by the modular inertial subsystem;
conducting at least one sonar depth pulse;
defining and recording the vessel's attitude corresponding to the corrected GPS coordinates to facilitate high-precision location of the pulse;
receiving and recording at least one sonar depth pulse reflectance echo; and
defining and recording the vessel's attitude corresponding to the corrected GPS coordinates to facilitate high-precision location of the reflectance echo.
